(19) United States
(12) Patent Application Publication
(10) Pub. No.: US 2018/0299347 A1
(43) Pub. Date: Oct. 18, 2018

(54) CLUTCH TEST STAND

(71) Applicant: ZF FRIEDRICHSHAFEN AG, Friedrichshafen (DE)

(72) Inventor: Albert FRÖHLER, Aussernzell (DE)

(21) Appl. No.: 16/061,351

(22) PCT Filed: Nov. 15, 2016
(86) PCT No.: PCT/EP2016/077647

§ 371 Date: Jun. 12, 2018

(30) Foreign Application Priority Data
Dec. 17, 2015 (DE) 10 2015 225 817.3

(51) Int. Cl. G01M 13/02

(52) U.S. Cl. CPC G01M 13/022; F16D 48/06

(57) ABSTRACT

A clutch test stand (1) for testing disk clutches (5, 5′). The clutch test stand has a first drive unit (20) and a second drive unit (21). The first drive unit (20) is drive-connected to a first shaft (22) and the first shaft (22) is arranged to rotate inside a first hollow shaft (23) which, for its part, can also rotate. The second drive unit (21) is drive-connected to a second shaft (24). The second shaft (24) is arranged to rotate in a second hollow shaft (25) which, for its part, can also rotate. The first and second hollow shafts (23, 25) can also be drive-connected to one another by a coupling (26).

This application is a National Stage completion of PCT/EP2016/1077647 filed Nov. 15, 2016, which claims priority from German patent application serial no. 10 2015 225 817.3 filed Dec. 17, 2015.

### FIELD OF THE INVENTION

The present invention relates to a clutch test stand for testing wet and dry friction-disk clutches, friction linings and complete.

### BACKGROUND OF THE INVENTION

Friction-disk clutches and brakes are used in automatic transmissions. Clutch test stands for such clutches, for example wet-running clutches, are known, in which within the test chamber the friction disks are held on so-termed inner and outer disk carriers. One of the disk carriers usually carries lining disks, whereas the other disk carrier carries steel disks. In the known test stands the disk pack in the test chamber undergoes a test under oil-tight and heat-insulated conditions, during which both the inner and the outer disk carriers are rotated.

As standard, such clutch test stands when viewed in the axial direction are designed such that the test chamber is arranged between the drives of the disk carriers. This type of arrangement is known as a dual-side arrangement. In automatic transmissions, during a gearshift process the disk carriers of the clutch, rotating at different speeds, are pressed together by a piston so that the clutch is dosed, i.e. the drive input and the drive output are synchronized to the same rotation speed.

Furthermore, clutch test stands are known in which the clutch to be tested is arranged in the test chamber at the same axial end as the shafts driving the respective disk carriers. This type of arrangement is called a single-side arrangement.

A disadvantage of the known dual-side clutch test stands is that due to limited configuration options and longer fitting times, they are often not very much used so that the high cost of purchasing them often seems unjustified.

### SUMMARY OF THE INVENTION

The purpose of the present invention is to propose an improved test stand for testing disk clutches.

According to the invention, this objective is achieved by the test stand for testing disk clutches according to the independent claim. Advantageous designs and further developments of the invention emerge from the dependent claims.

The invention relates to a clutch test stand for testing disk clutches, which comprises a first drive unit and a second drive unit, such that the first drive unit is drive-connected to a first shaft and the first shaft is arranged to rotate inside a first hollow shaft which is itself able to rotate. The distinguishing feature of the clutch test stand according to the invention is that the second drive unit is drive-connected to a second shaft, and the second shaft is arranged to rotate inside a second hollow shaft which is itself able to rotate, and the first and second hollow shafts can be brought into driving connection with one another by coupling means.

Thus, the first drive unit can drive the first shaft and the second drive unit can drive the second shaft. At the same time the first and second hollow shafts can be in driving connection with one another. Compared with known clutch test stands, this design allows substantially greater flexibility in relation to the possible configurations and application options, which for example enables the clutch test stand according to the invention to be used much more. In turn, that increases the value-for-money of the clutch test stand according to the invention.

Depending on the specific profile of requirements to be fulfilled by the clutch test stand, the first and second drive units can be of identical design, or they may differ from one another. For example, they may have the same or different rotational speed ranges, torque ranges or moments of inertia. The moment of inertia influences in particular the dynamic behavior of the drive units.

The disk clutches to be tested can be both wet-running and dry-running disk clutches. The clutch test stand according to the invention is suitable for testing clutches of both types equally well. The same applies to individual friction linings, for example for brakes, and even complete clutches such as ones for change-speed transmissions.

The first and second shafts are preferably arranged parallel to one another. Likewise, it is preferable for the first and second hollow shafts to be arranged parallel to one another.

Preferably, the first drive unit is arranged coaxially with the first shaft and the second drive unit is correspondingly preferably arranged coaxially with the second shaft.

Advantageously, the first shaft is a solid shaft. Also advantageously, the second shaft is likewise a solid shaft.

Although the first and second hollow shafts can be drive-connected to one another, it is not absolutely necessary—depending on the type of testing process to be carried out in each case—for the first and second hollow shafts actually to be in driving connection with one another. The possibility of connecting them increases the flexibility and application options of the clutch test stand,

According to a preferred embodiment of the invention it is provided that the coupling means are designed as a belt drive, a chain drive or a gearwheel drive. These coupling means are all equally suitable for the reliable production of a load-bearing and dynamically drivable coupling of the first hollow shaft to the second hollow shaft.

In a further preferred embodiment of the invention it is provided that the clutch test stand also comprises short-circuiting means such that the short-circuiting means are designed to form a driving short-circuit between the first shaft and the first hollow shaft and/or between the second shaft and the second hollow shaft. Thus, a drive coupling can be formed between the first shaft and the first hollow shaft or between the second shaft and the second hollow shaft. This enables the force flow to be transmitted from the first drive unit to the first shaft, from the first shaft via the short-circuiting means to the first hollow shaft and from the first hollow shaft via the coupling means to the second hollow shaft. Thus, the second shaft can be driven by the second drive unit and the second hollow shaft by the first drive unit. This makes it possible to control or regulate the rotational speed of the second shaft by means of the second drive unit and to control or regulate the rotational speed of the second hollow shaft by means of the first drive unit. Likewise, however, the force flow can be transmitted from the second drive unit to the second shaft, from the second shaft via the short-circuiting means to the second hollow shaft and from the second hollow shaft via the coupling means to the first hollow shaft.

In the context of the invention the term “driving short-circuit” is understood to mean a rotationally fixed coupling,

The short-circuiting means can for example be in the form of a flange which can be attached at the same time to the first shaft and the first hollow shaft so that the first shaft and the first hollow shaft form a drive short-circuit or connection, The short-circuiting means or flange can in like manner be attached to the second shaft and the second hollow shaft, so that the second shaft and the second hollow shaft also form a drive short-circuit or connection. This produces a reliable, load-bearing and space-saving drive coupling.

According to a further preferred embodiment of the invention it is provided that the first shaft and the second shaft are in each case designed to be drive-coupled to outer disks of a disk clutch, and the first hollow shaft and the second hollow shaft are in each case designed to be drive-coupled to inner disks of the disk clutch. In that way a disk clutch to be tested can be coupled both to the first shaft and to the first hollow shaft, or both to the second shaft and to the second hollow shaft. Since a disk clutch usually comprises two oppositely rotatable layers of disks, namely inner disks and outer disks, these can be driven independently of one another. Inasmuch as for a testing process it is not necessary for both the inner disks and the outer disks of a disk clutch to be driven at the same time, the first shaft can be drive-coupled to the inner disks and the first hollow shaft drive-coupled to the outer disks of a first disk clutch to be tested, whereas the second shaft can be drive-coupled to the inner disks and the second hollow shaft drive-coupled to the outer disks of a second disk clutch to be tested. Thus, up to two disk clutches at the same time can be tested in the clutch test stand.

In a further preferred embodiment of the invention it is provided that the first drive unit is drive-connected to the first shaft via a first compensating coupling and/or a first torque sensor, and the second drive unit is drive-connected to the second shaft via a second compensating coupling and/or a second torque sensor. This gives the advantage that by means of the compensating coupling axial, radial and angular shaft offsets can be compensated. Thus, the clutch test stand can be operated reliably even if one or more of the offsets exists. A further advantage is that by virtue of the torque sensors the respective torques with which the disk clutches to be tested are acted upon can be determined exactly. Thus, the test conditions can be registered more precisely.

According to another preferred embodiment of the invention, it is provided that the ability of the first hollow shaft to rotate can be blocked by first blocking means, and the ability of the second hollow shaft to rotate can be blocked by second blocking means. Advantageously, this enables the testing of a braking action of the disk clutches to be tested. Namely, since the rotating ability of the first or second hollow shaft is blocked, so also is the rotational ability of the outer disks of the first or second disk clutch to be tested. In contrast the inner disks can still be driven by the first or second shaft. If the disk clutches are then actuated in the closing direction, the disk clutches to be tested act as brakes. Thus, the blocking means enable the clutch test stand to be simply and quickly converted from the clutch testing operation of a single clutch to a brake testing operation of two disk clutches. This minimizes the operating complexity and the refitting times.

The blocking means can for example be in the form of screws by means of which the first or second hollow shafts can be connected to a housing of the clutch test stand in a rotationally fixed manner.

According to a further preferred embodiment of the invention it is provided that the clutch test stand has a first axial actuator for actuating a first disk clutch to be tested and a second axial actuator for actuating a second disk clutch to be tested. This enables the disk clutches being tested to be actuated in the closing and in the opening direction, By actuating them in the closing direction, in particular the braking efficacy of the disk clutched being tested can be checked.

Preferably, it is provided that a first or second axial force applied by the first or second axial actuator is continuously adjustable. This enables sensitive and precise testing of the disk clutches under the effect of different axial forces,

In a particularly preferred embodiment of the invention it is provided that the clutch test stand comprises a first axial force sensor and/or a first axial path sensor, and/or that the clutch test stand comprises a second axial force sensor and/or a second axial path sensor. In that way the axial force applied by the first axial actuator or the axial displacement produced by the first axial actuator can be determined reliably. Likewise, the axial force applied by the second axial actuator or the axial displacement produced by the second axial actuator can be determined reliably. This improves the precision of the testing of the disk clutches still more, since the respective test conditions can be determined accurately.

According to a very particularly preferred embodiment of the invention, it is provided that the first and second axial actuators can be actuated by electro-hydraulic means. This enables precise control or regulation of the axial actuators at the same time as ensuring the application of higher axial forces.

In a further preferred embodiment of the invention it is provided that the first drive unit is in the form of a first electric motor and the second drive unit is in the form of a second electric motor. Electric motors have the advantage that they can be controlled or regulated with precision as regards their rotational speed and the torque they produce. They are also compact in form and thanks to their emission-free operation they are suitable for use in workshops,

Preferably, it is provided that the first shaft is mounted on the inner diameter and the first hollow shaft on the outer diameter conjointly on a non-rotating first bearing pin, and the second shaft is mounted on the inner diameter and the second hollow shaft on the outer diameter conjointly on a non-rotating second bearing pin. By virtue of these bearings almost any desired rotational speed differences can exist between the first shaft and the first hollow shaft or between the second shaft and the second hollow shaft, since the shafts and hollow shafts are in each case mounted on a static bearing element. In this way the loads relating to bearing and sealing are minimized, without having to restrict the necessary rotational speed range because of that. Furthermore, as viewed axially there is a common side or common end of the shafts available to enable the actuation of the clutch and the measurements involved.

According to a further preferred embodiment of the invention it is provided that the clutch test stand comprises a first test head which can be filled with oil and is oil-tight, for receiving a first disk clutch to be tested, and a second test head which can be filled with oil and is oil-tight, for receiving a second disk clutch to be tested. The disk clutches to be tested are placed in the first or second test head and drive-coupled to the first or second shaft and the first or second hollow shaft, with only one disk clutch at a time placed in each test head. Since the test heads are designed to be filled with oil and are oil-tight, they are also advantageously suitable for the testing of wet-running disk clutches.

Particularly preferably, it is provided that the test heads are integrated in an oil circuit that enables the oil to circulate through the test heads. Moreover, in this way a substantially constant oil temperature can be ensured. That favors the exact reproducibility or comparability of testing processes.

In a further preferred embodiment of the invention it is provided that the first drive unit is arranged at a first axial end of the first shaft and the first test head is arranged at a second axial end of the first shaft, whereas the second drive unit is arranged at a first axial end of the second shaft and the second test head is arranged at a second axial end of the second shaft. This configuration of the clutch test stand corresponds to the so-termed single-side arrangement and enables a simple replacement of the disk clutches to be tested, since no test stand components have to be removed in order to insert or remove a disk clutch into or from a test head. This shortens the idle times of the clutch test stand.

### BRIEF DESCRIPTION OF THE DRAWINGS

Below, an example of the invention is explained with reference to embodiments illustrated in the figures, which show:

FIG. 1: A schematic representation of a clutch test stand known from the prior art,

FIG. 2: A schematic representation of an example structure of a clutch test stand according to the invention, in a first configuration, and

FIG. 3: A schematic representation of an example structure of a clutch test stand according to the invention, in a second configuration.

In all the figures the same objects, functional units and comparable components are denoted by the same indexes. As regards their technical features these objects, functional units and comparable components are made identically unless explicitly or implicitly indicated in the description.

### DETAILED DESCRIPTION OF THE PREFERRED EMBODIMENTS

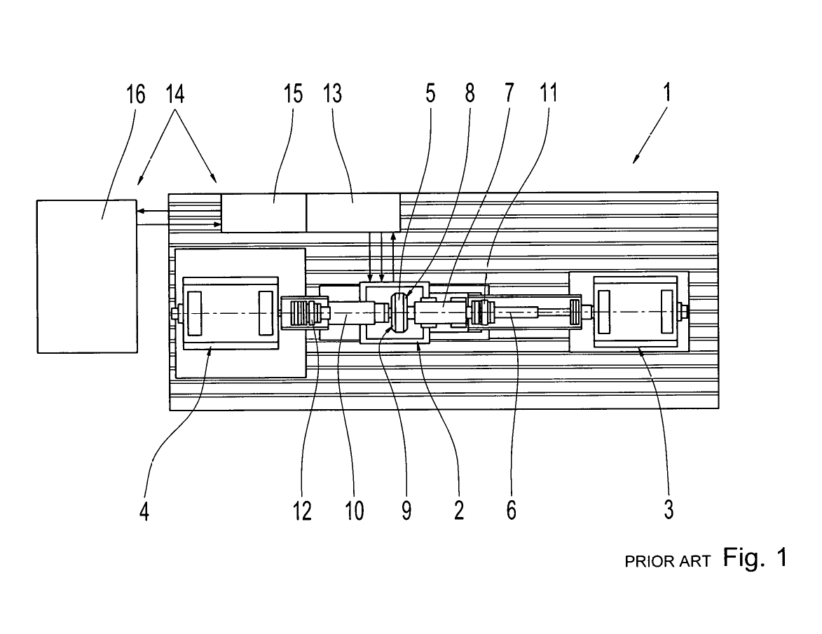

FIG. 1 shows a schematic representation of a clutch test stand 1 known from the prior art, in the so-termed dual-side arrangement. In accordance with the principle of the dual-side arrangement, a test head 2 is arranged axially between a drive input unit 3 and a drive output unit 4. A disk clutch 5 is arranged in the test chamber 2. By way of a driveshaft 6, a drive input side 8 of the disk clutch 5 is acted upon by a torque. When an axial actuator 7 actuates the disk clutch 5 in its closing direction, the disk clutch 5 transmits the torque, via its drive output side 9, to the drive output shaft 10. For its part, the drive output shaft 10 is acted upon by the drive output unit 4 with an opposite torque so as to be able to test the behavior of the disk clutch in high-load operation. In addition the drive input shaft 9 has a drive input torque sensor 11 which detects the torque produced by the drive input unit 3. Likewise, the drive output shaft 10 has a drive output torque sensor 12 which detects the torque acting between the drive output side 9 of the disk clutch 5 and the drive output unit 4. Thus, for example, a torque transmission capacity of the disk clutch 5 can be determined. Furthermore the known clutch test stand comprises a test oil system 13 which supplies the test head 2 with test oil via a test oil circuit, as indicated by the arrows. Immediately adjacent to the test oil system 13 is arranged a cooling oil system 14 with a cooling oil circuit indicated by arrows, in which a heat exchanger 15 and a cooling unit 16 are integrated. The heat exchanger 15 takes up heat from the test oil circuit and carries it away. Thus, a wet-running disk clutch 5 can be continually supplied with cooling test oil. There is no hydraulic short-circuit between the test oil system 13 and the cooling oil system 14, i.e. the heat exchange between the test oil and the cooling oil takes place via a separating element. To place the disk clutch 5 to be tested into the test chamber 2 or remove it again therefrom, it is necessary to displace or remove the drive input unit 3, the driveshaft 6 and the axial actuator 7. For this, a plurality of locking and closure mechanisms have to be opened, which as a rule is time-consuming and so results in comparatively long idle times of the known clutch test stand 1.

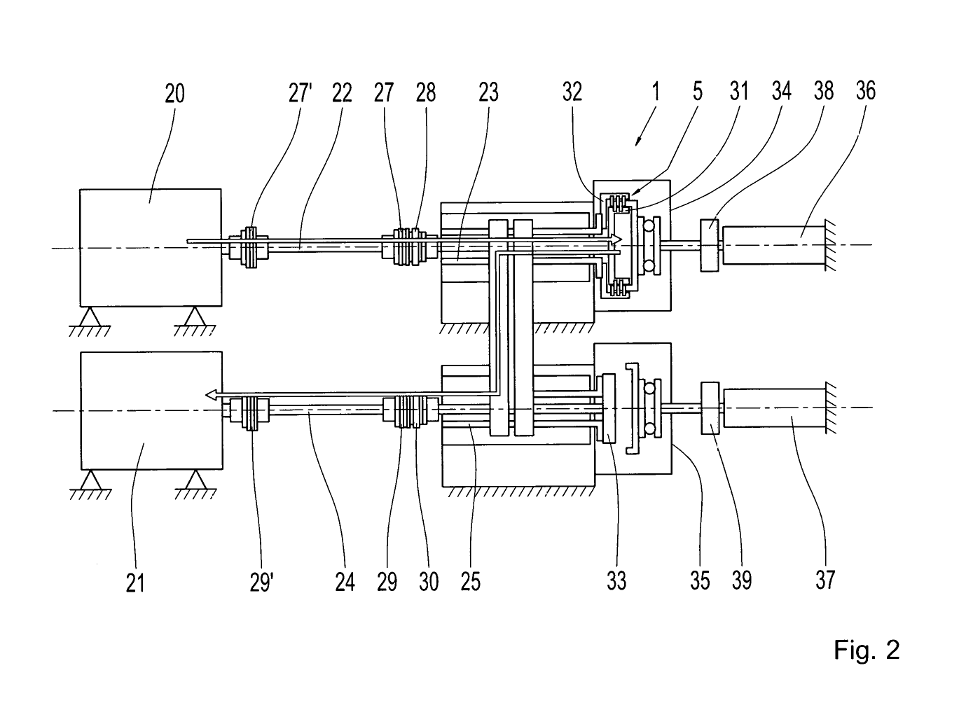

FIG. 2 shows a schematic representation of an example embodiment of a clutch test stand 1 according to the invention, in a first configuration. The clutch test stand 1 shown as an example is designed for testing wet-running and dry-running disk clutches 5. It comprises a first drive input unit 20 and a second drive input unit 21. The first drive input unit 20 is drive-connected to a first shaft 22 that is fitted through and able to rotate in a first hollow shaft 23, which for its part can also rotate. As can be seen, the first shaft 22 projects some way out of the first hollow shaft 23 in the direction toward the first drive input unit 20. The second drive input unit 21 is drive-connected to a second shaft 24 arranged to rotate in a second hollow shaft 25, which for its part can also rotate. As can be seen, the second shaft 24 also projects some way out of the second hollow shaft 25 in the direction toward the second drive unit 21. In this example the first drive unit 20 is in the form of a first electric motor 20 and the second drive unit 21 is in the form of a second electric motor 21. By way of coupling means 26, which are designed, for example, as a belt drive 26, the first and second hollow shafts 23, 25 are drivingly connected to one another in the configuration of the clutch test stand 1 shown in FIG. 2. As can also be seen from FIG. 2, two first compensation couplings 27, 27′ and a first torque sensor 28 are arranged on the first shaft 22. In like manner, two second compensation couplings 29, 29′ and a second torque sensor 30 are arranged on the second shaft 24. The compensation couplings 27, 27′ and 29, 29′ thereby allow the compensation of axial, radial and angular shaft offsets between the first drive unit 20 and the first shaft 22 and between the second drive unit 21 and the second shaft 24, respectively. The torque sensors 28 and 30 enable the detection of torques that act upon the first shaft 22 or the second shaft 24, respectively. The first shaft 22 and the second shaft 24 are in each case designed to be drive-connected to outer disks 31 of a disk clutch 5 and the first hollow shaft 23 and the second hollow shaft 25 are in each case designed to be drive-connected to inner disks 32 of the disk clutch 5. However, in the example embodiment of FIG. 2 only the first shaft 22 and the first hollow shaft 23 are coupled to the outer disks 31 and the inner disks 32, respectively, of the disk clutch 5. In contrast, the second shaft 24 and the second hollow shaft 25 are short-circuited or coupled to one another by short-circuiting means 33, i.e. the second shaft 24 and the second hollow shaft 25 are drivingly-connected solidly to one another in a rotationally fixed manner. Thus, any rotational movement of the second shaft 24 relative to the second hollow shaft 25 is prevented by the short-circuiting means 33. So, a torque produced by the second drive unit 21 is transmitted by virtue of the short-circuiting means 33 from the second shaft 24 to the second hollow shaft 25. In this example the short-circuiting means 33 are in the form of a flange which, instead of a disk clutch, can be coupled to the second shaft 24 and the second hollow shaft 25. Both the disk clutch 5 and the short-circuiting means 33 are arranged in respective test heads 34 and 35. In this example the test heads 34 and 35 are made oil-tight and are suitable for filling with a test oil so wet-running disk clutches 5 too can be tested. The clutch test stand 1 shown as an example also comprises a first axial actuator 36 for actuating the disk clutch 5 and a second axial actuator 37 for actuating a further disk clutch which in FIG. 2, however, has not been fitted into the test head 35. The first axial actuator 36 and the second axial actuator 37 can be actuated electro-hydraulically, i.e. the axial forces produced by the first actuator 36 and the second actuator 37 are produced by the delivery of a hydraulic fluid into cylinders of the axial actuators 36 and 37. This results in a displacement of the pistons in the cylinders of the axial actuators 36 and 37, and consequently to an axial movement of a piston rod in each case. Since the hydraulic fluid is provided by one or more electrically driven pumps, one speaks of electro-hydraulically actuated axial actuators 36, 37. By virtue of the fluid pressure produced by the pumps, the axial forces produced by the axial actuators 36, 37 can already be determined by computer means. In addition the clutch test stand 1 of FIG. 2 also has axial force sensors 38 and 39, in order to detect the axial forces directly and comparatively more precisely. As can also be seen in FIG. 2, the first drive unit 20 is arranged at a first axial end of the first shaft 22 and the first test head 34 is arranged at a second axial end of the first shaft 22. In like manner, the second drive unit 21 is arranged at a first axial end of the second shaft 24 and the second test head 25 is arranged at a second axial end of the second shaft 24. Such a configuration of the clutch test stand 1 is also known as a so-termed single-side arrangement. This arrangement enables a comparatively quick and simple positioning or fitting of disk clutches 5 to be tested in the test heads 34 or 35, since it is only necessary to draw the axial actuators 36,37 slightly back. Thus, idle times of the clutch test stand 5 illustrated are made shorter.

The configuration of the clutch test stand 1 shown in FIG. 2 is designed for testing a clutch behavior of a disk clutch 5. For this, a force flow runs in the clutch test stand 1 along the arrows shown. The first drive unit 20 produces a torque, which is transmitted via the first shaft 22 to the outer disks 31 of the disk clutch 5. Depending on the axial force produced by the first axial actuator 36, the outer disks 31 transmit the torque to a greater or lesser extent to the inner disks 32 of the disk clutch 5. The higher the axial force produced, the greater the torque-transmitting capacity of the disk clutch 5. From the inner disks 32, the torque is now transmitted to the first hollow shaft 23 which, for its part, transmits the torque via the belt drive 26 to the second hollow shaft 25. Since the second hollow shaft 25 is drive-coupled to the second shaft 24 by the short-circuiting means 33, the torque is transmitted by the second shaft 24 to the second drive unit. In addition, depending on the test situation the second drive unit can also produce an opposite torque in order to simulate a high-load situation for the disk clutch 5. During this, the forces or torques transmitted from the outer disks 31 to the inner disks 32 can be determined precisely at any time by the torque sensors 28 and 30. In addition, by means of the axial force sensor 38 an axial-force-dependent torque transmission capability of the disk clutch 5 can be determined.

According to a further example embodiment of the invention also illustrated in FIG. 2, instead of axial force sensors 38, 39 the clutch test stand 1 comprises a first axial path sensor 38 and a second axial path sensor 39. In that way the axial force applied by virtue of the fluid pressure produced by the pumps can be determined, while at the same time the axial movement caused by the axial force can also be detected.

In an example embodiment (not shown), the clutch test stand 1 of FIG. 2 comprises both first and second axial force sensors, and first and second axial path sensors.

According to a further example embodiment (again not shown), the clutch test stand 1 of FIG. 2 comprises in addition a known test oil system 13 and a known cooling oil system 14, which together enable cooled test oil to be supplied to the test heads 34 and 35.

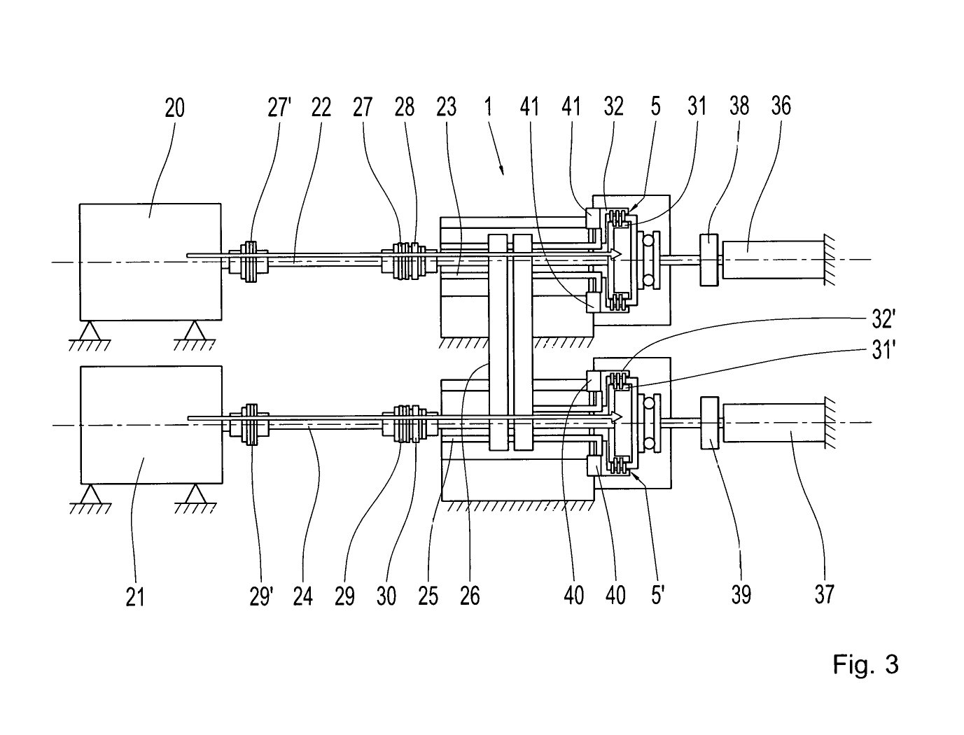

FIG. 3 shows a schematic representation of an example embodiment of the clutch test stand 1 according to the invention, in a second configuration. The clutch test stand 1 shown in FIG. 3 is identical to the clutch test stand in FIG. 2, but designed for testing the braking behavior of the disk clutches 5 and 5′. Disk clutch 5 in this case represents a first disk clutch 5 and disk clutch 5′ represents a second disk clutch 5′. In detail, the configuration of the clutch test stand 1 in FIG. 3 differs from that in FIG. 2, in that the belt drive 26 is not drive-connected to the first hollow shaft 23 and the second hollow shaft 25. Instead, the belt drive 26 in this example is drive-decoupled from at least the first hollow shaft 23 or the second hollow shaft 25. A torque of the first hollow shaft 23 is therefore not transmitted to the second hollow shaft 25, and conversely. Furthermore, instead of the short-circuiting means 33, second blocking means 40 are arranged on the second hollow shaft 25, which block any rotation of the second hollow shaft 25 relative to a housing of the clutch test stand 1. In like manner, first blocking means 41 are also arranged on the first hollow shaft 23, which prevent the first hollow shaft 23 from rotating relative to a housing of the clutch test stand 1. The first disk clutch 5 is arranged in the first test head 34 and the second disk clutch 5′ is arranged in the second test head 35. The first disk clutch 5 is drive-connected, via its outer disks 31, to the first shaft 22. Via its inner disks 32 the first disk clutch 5 is drive-connected to the first hollow shaft 23. Since the first hollow shaft 23 cannot rotate, rotation of the inner disks 32 of the first disk clutch 5 is also blocked. In an identical manner the outer disks 31′ of the second disk clutch 5′ are drive-connected to the second shaft 24. Via its inner disks 32′ the second disk clutch 5′ is drive-coupled to the second hollow shaft 25. Since the second shaft 25 cannot rotate, the rotation of the inner disks 32′ of the second disk clutch 5′ is also blocked.

A force flow in the clutch test stand 1 for testing the braking behavior of the disk clutches 5 and 5′ runs along the arrows shown. The first drive unit 20 produces a torque which is transmitted, via the first shaft 22, to the outer disks 31 of the first disk clutch 5. Depending on the axial force produced by the first axial actuator 36, the outer disks 31 transmit the torque to a greater or lesser extent to the inner disks 32 of the disk clutch 5. Since rotational movement of the inner disks 32 of the disk clutch 5 is blocked by the first blocking means 41, depending on the axial force applied by the axial actuator 36 there is a more or less effective braking action. During this, torque transmitted from the outer disks 31 to the inner disks 32 can be determined precisely at any time by the torque sensor 28. hi addition, by means of the axial force sensor 38 an axial-force-dependent torque transmission capability of the first disk clutch 5 can be determined. The braking behavior of the disk clutch 5′ can be tested in an identical manner. The second drive unit 22 produces torque which is transmitted, via the second shaft 24, to the outer disks 31′ of the second disk clutch 5′. Depending on the axial force produced by the second axial actuator 37, the outer disks 31′ transmit the torque to a greater or lesser extent to the inner disks 32′ of the second disk clutch 5′. Since rotational movement of the inner disks 32′ of the second disk clutch 5′ is blocked by the second blocking means 40, depending on the axial force applied by the axial actuator 37 there is a more or less effective braking action. During this, torque transmitted from the outer disks 31′ to the inner disks 32′ can be determined precisely at any time by the torque sensor 30. In addition, by means of the axial force sensor 39 an axial-force-dependent torque transmission capability of the second disk clutch 5′ can be determined. Thus, the clutch test stand 1 shown as an example enables the simultaneous testing of t braking behavior of two disk clutches 5 and 5′.

### INDEXES

1 Clutch test stand
2 Test head
3 Drive unit
4 Drive unit
5 Disk clutch, first disk clutch
6 Driveshaft
7 Axial actuator
8 Drive input side of the disk clutch
9 Drive output side of the disk clutch
10 Drive output shaft
11 Drive input torque sensor
12 Drive output torque sensor
13 Test oil system
14 Cooling oil system
15 Heat exchanger of the coding oil system
16 Coding unit of the cooling oil system
20 First drive unit, first electric motor
21 Second drive unit, second electric motor
22 First shaft
23 First hollow shaft
24 Second shaft
25 Second hollow shaft
26 Coupling means, belt drive
27, 27′ First compensation coupling
28 First torque sensor
29, 29′ Second compensation coupling
30 Second torque sensor
31 Outer disks of the first disk clutch
31′ Outer disks of the second disk clutch
32 Inner disks of the first disk clutch
32′ inner disks of the second disk clutch
33 Short-circuiting means, flange
34 First test head
35 Second test head
36 First axial actuator
37 Second axial actuator
38 First axial force sensor, first axial path sensor
39 Second axial force sensor, second axial path sensor
40 Second blocking means
41 First blocking means

1-12. (canceled)

13. A clutch test stand (1) for testing disk clutches (5, 5′), the clutch test stand comprising a first drive unit (20) and a second drive unit (21), the first drive unit (20) being drive-connected to a first shaft (22), and the first shaft (22) being arranged to rotate inside a first hollow shaft (23) which is also rotatable,
the second drive unit (21) being drive-connected to a second shaft (24), the second shaft (24) being arranged to rotate inside a second hollow shaft (25) which is also rotatable, and
the first and the second hollow shafts (24, 25) being drive-connectable to one another by coupling means (26).

14. The clutch test stand (1) according to claim 13, wherein the coupling means (26) is one of a belt drive (26), a chain drive and a gearwheel drive.

15. The clutch test stand (1) according to claim 13, further comprising short-circuiting means (33), and the short-circuiting means (33) is designed to at least one of drivingly short-circuit the first shaft (22) and the first hollow shaft (23), and drivingly short-circuit the second shaft (24) and the second hollow shaft (25).

16. The clutch test stand (1) according to claim 13, wherein the first shaft (22) and the second shaft (24) are each designed to be drive-coupled to outer disks (31, 31′) of respective disk clutches (5, 5′), and the first hollow shaft (23) and the second hollow shaft (25) are each designed to be drive-coupled to inner disks (32, 32′) of the respective disk clutches (5, 5′).

17. The clutch test stand (1) according to claim 13, wherein the first drive unit (20) is drive-connected to the first shaft (22) via at least one of a first compensation coupling (27, 27) and a first torque sensor (28), and the second drive unit (21) is drive-connected to the second shaft (24) via at least one of a second compensation coupling (29, 29′) and a second torque sensor (30).

18. The clutch test stand (1) according to claim 13, wherein rotation of the first hollow shaft (23) is blockable by first blocking means (41) and rotation of the second hollow shaft (25) is blockable by second blocking means (40).

19. The clutch test stand (1) according to claim 13, further comprising a first axial actuator (36) for actuating a first disk clutch (5) to be tested and a second axial actuator (37) for actuating a second disk clutch (5) to be tested.

20. The clutch test stand (1) according to claim 19, further comprising at least one of a first axial force sensor (38), a first axial path sensor, a second axial force sensor (39) and a second axial path sensor.

21. The clutch test stand (1) according to claim 19, wherein the first axial actuator (36) and the second axial actuator (37) are actuatable by electro-hydraulic means.

22. The clutch test stand (1) according to claim 13, wherein the first drive unit (20) is a first electric motor (20), and the second drive unit (21) is a second electric motor (21).

23. The clutch test stand (1) according to claim 13, further comprising a first test head (34) that is fillable with oil and is oil-tight for receiving a first disk clutch (5) to be tested, and a second test head (35) that is finable with oil and is oil-tight for receiving a second disk clutch (5) to be tested.

24. The clutch test stand (1) according to claim 23, wherein the first drive unit (20) is arranged at a first axial end of the first shaft (22) and the first test head (34) is arranged at a second axial end of the first shaft (22), and the second drive unit (21) is arranged at a first axial end of the second shaft (24) and the second test head (35) is arranged at a second axial end of the second shaft (24).

25. A clutch test stand for testing disk clutches, the clutch test stand comprising:
a first drive unit being drivingly connected to a first shaft, the first shaft extending through a first hollow shaft and being rotatable relative to the first hollow shaft, and the first hollow shaft being rotatable;
a second drive unit being drivingly connected to a second shaft, the second shaft extending through a second hollow shaft and being rotatable relative to the second hollow shaft, and the second hollow shaft being rotatable; and
the first hollow shaft and the second hollow shaft being drivingly connected to each other by a coupling.

26. The clutch test stand according to claim 25, wherein
the first drive unit is drivingly connected, via a first compensating coupling, to the first shaft, and the first shaft has a first torque sensor which determines torque acting on the first shaft; and
the second drive unit is drivingly connected, via a second compensating coupling, to the second shaft, and the second shaft has a second torque sensor which determines torque acting on the second shaft.

27. The clutch test stand according to claim 26, wherein the second shaft is connectable to the second hollow shaft by a locking member such that the second shaft and the second hollow shaft rotate in unison with one another.

28. The clutch test stand according to claim 26, wherein the first shaft is connected to outer disks of a first clutch to be tested and the first hollow shaft is connected to inner disks of the first clutch to be tested; and
the second shaft is connected to outer disks of a second clutch to be tested and the second hollow shaft is connected to inner disks of the second clutch to be tested.

29. The clutch test stand according to claim 28, wherein the first hollow shaft has a first blocking member which is connectable to a housing of the clutch test stand to prevent rotation of the first hollow shaft; and
the second hollow shaft has a second blocking member which is connectable to the housing of the clutch test stand to prevent rotation of the second hollow shaft.
